(19) United States
(12) Patent Application Publication
(10) Pub. No.: US 2004/0223316 A1
(43) Pub. Date: Nov. 11, 2004

(54) Illuminable component

(75) Inventors: Martina Bachmann, Eching (DE); Joachim Wilkens, Olching (DE); Wolfgang Froewis, Allershausen (DE)

Correspondence Address: CROWELL & MORING LLP, INTELLECTUAL PROPERTY GROUP, P.O. BOX 14300, WASHINGTON, DC, 20044-4300, US

(73) Assignee: Bayerische Motoren Werke AG, Muenchen (DE)

(21) Appl. No.: 10/833,091

(22) Filed: Apr. 28, 2004

(30) Foreign Application Priority Data
May 8, 2003 (DE) 103 20 467.9

(51) Int. Cl. F21V 9/16

(52) U.S. Cl. 362/84

(57) ABSTRACT

An illuminable component includes a basic support, a voltage transducer, a luminous foil, a transparent intermediate part, and a non-illuminable part. The basic support has an opening, and the voltage transducer is disposed in the opening of the basic support. The luminous foil is connected to the voltage transducer and is disposed between the basic support and the transparent intermediate part. Disposed between the luminous foil and the non-illuminable part, the transparent intermediate part has an elevation, which extends through the non-illuminable part from one side of the non-illuminable part to the other side and projects over to the other side. The portion of the elevation projecting over the non-illuminable part forms a symbol. The voltage transducer is fastened to one of the other elements of the illuminable component.

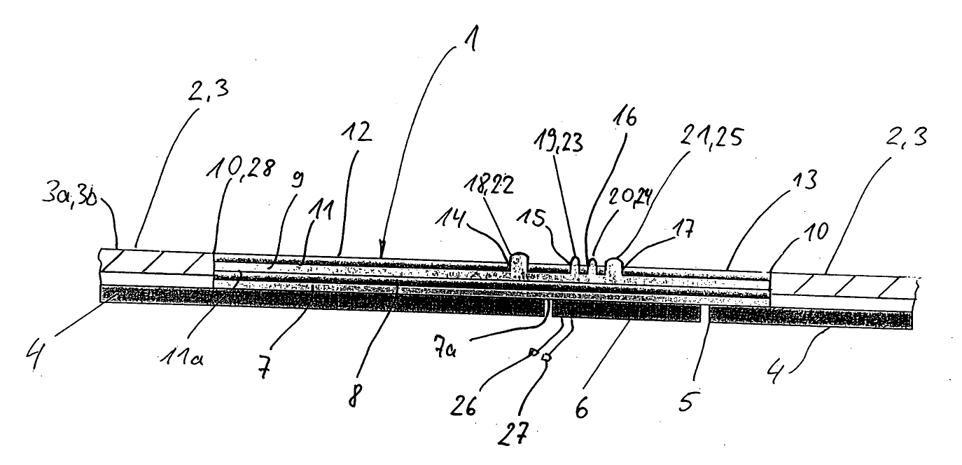

### BACKGROUND AND SUMMARY OF THE INVENTION

This application claims the priority of German Patent Document No. 103 20 467.9, filed May 8, 2003, the disclosure of which is expressly incorporated by reference herein.

The invention relates to an illuminable component. The illuminable component can shine, for example, in a written line or in other symbols and can be used in a visible area of a vehicle.

An illuminable component of the above-mentioned type is known from German Patent Document DE 44 21 942.

It is an object of the invention to provide an illuminable component which has a simple construction.

This object is achieved by the illuminable component described and claimed hereinafter.

The illuminable component according to the invention has a luminous foil by which a full-surface illumination of a visible surface of the illuminable component is advantageously achieved. In the case of the illuminable component according to the invention, a voltage transducer is connected in one piece with the illuminable component, so that the mounting is simplified. As a result of the illuminable component according to the invention, a three-dimensional irradiation is achieved by an advantageous shaping of an intermediate part allowing the generated light to pass through.

The glass-type and/or translucent intermediate part according to the invention is provided with elevations which at least partially have a convex arching. As a result of the construction of convex elevations according to the invention over the solid angle, the irradiation of the illuminated surface appears homogeneous.

The elevations according to the invention project out of openings which are constructed in a wall part surrounding the illuminable component or are formed by at least one surface part arranged on the intermediate part. The projection of the existing elevations according to the invention over the surrounding wall part or the surface parts is preferably in a range of approximately 1 to 8 mm.

In an advantageous embodiment, the surface parts arranged on the intermediate part have at least the same color and/or the same material as the surrounding wall part.

In an advantageous embodiment, the voltage transducer is a converter or an inverter. As a result of the use of a corresponding inverter, a digital light effect can be achieved.

In the case of the illuminable component according to the invention, at least one additional foil, for example, a transluminescent chrome foil or a colored foil is arranged on the intermediate part and/or on the luminous foil or luminescent foil. As a result, the illuminated surface, in daylight, has a high-quality chrome appearance or appears in a color appropriate for the design. With this additional foil, it is prevented that an electronic system or other parts situated below the illuminable part are visible and result in an undesirable visual effect.

Other objects, advantages and novel features of the present invention will become apparent from the following detailed description of the invention when considered in conjunction with the accompanying drawings.

### BRIEF DESCRIPTION OF THE DRAWING

The FIGURE is a sectional view of an illuminable component of the present invention.

### DETAILED DESCRIPTION OF THE DRAWING

In the embodiment shown in the FIGURE, the illuminable component 1 is arranged in a sealed-off manner, for example, in an opening or a recess 10 which is constructed in a side member 2 of a vehicle, which is not shown in detail, in a visible entrance area of a door opening, for example, in a section of an entrance ledge 3.

The illuminable component 1 has a basic support 4 which is situated below an exterior surface 3a of a wall part 3b of the entrance ledge 3. The basic support 4 is provided with a recess or opening 5. In the recess 5 of the basic support 4, a voltage transducer 6 is arranged which is fastened in one piece to an underside 7a of a luminous foil or luminescent foil 7 and/or to the basic support 4.

An additional foil 8, for example, a chrome foil and/or a colored foil, is provided above the luminous foil 7. On the top side of the additional foil 8, a transparent intermediate part 9 is arranged which consists of a glass-type material or of a transparent plastic material.

In the illustrated embodiment, surface parts or insertion parts 12, 13 are arranged on an outward pointing top side 11 of the intermediate part 9, which surface parts or insertion parts 12, 13 have openings 14, 15, 16 and 17. The shape and the course of the openings 14, 15, 16 and 17 correspond to a desired illuminable written line or illuminable symbols or other signs. The insertion parts 12 and 13 are fastened to the intermediate part 11 by known chemical and/or form-locking fastening measures, such as gluing or clipping.

In one embodiment, the insertion parts 12, 13 are mutually connected, so that, for example, a closed outer edge 28 is obtained. In another embodiment, as an alternative or in addition to the insertion parts 12, 13, sections of the surrounding wall parts 3b, for example, of the entrance ledge 3, are constructed in the form of the desired not illuminated surface, which are constructed above the luminous foil 7.

Elevations 18 to 21, which each have an outward-arched or convex surface 22, 23, 24 and 25, project through the openings 14 to 17. As a result of the respective rounded surface 22 to 25, the light coming from the luminous foil 7 is irradiated in a uniform, full-surface and spatial manner.

The voltage transducer 6 is an inverter or a converter which is connected by way of lines 26 and 27 with an on-board electric system of the vehicle, for example, with a switch. In the case of the above-mentioned state of the art, the switching-on of the luminous foil 7 can take place by way of an existing touch sensitive switch which is constructed, for example, for operating a vehicle occupant compartment lighting system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Illuminable component, having at least one illuminable area which forms written lines, symbols, letters, numbers, figures or the like, the illuminable area having a transparent intermediate part, having a luminous foil arranged below the intermediate part, the luminous foil being connected to a voltage transducer which, if required, can be connected by way of switchable devices with the on-board electrical system, wherein the illuminable component has a basic support on which the luminous foil, the transparent intermediate part and parts of the non-illuminable area are arranged, in that the basic support has at least one opening in which the voltage transducer is fastened in one piece to a surface of the component, and in that the intermediate part has elevations which project over the non-illuminable area.

2. Component according to claim 1, wherein the illuminable component additionally has an additional foil which is transparent for the light generated by the luminous foil and generates a colored and/or a metallic impression of the illuminable area in daylight.

3. Component according to claim 1, wherein the additional foil has a translucent (transluminescent) chrome foil and/or a colored foil.

4. Component according to claim 3, wherein the elevations have a convexly outward-arched surface which cause a uniform irradiation of the light generated by the luminous foil.

5. Component according to claim 4, wherein the illuminable component is constructed in one piece, in that the intermediate part has a carrier function for the arrangement of the luminous foil and, if required, of the additional foil on its underside, and a carrier function for fastening the insertion parts on its top side.

6. Component according to claim 5, wherein sections of the insertion parts project over the lateral edges of the illuminable component and are arranged on a surface of the wall part or are integrated in corresponding recesses of the wall part.

7. Component according to claim 6, wherein sections of the surrounding wall part are arranged on a top side of the intermediate part or in one correspondingly shaped recess respectively of the intermediate part.

8. Component according to claim 1, wherein the voltage transducer causes a digital effect of the illumination.

9. Component according to claim 1, wherein the elevations have a convexly outward-arched surface which cause a uniform irradiation of the light generated by the luminous foil.

10. Component according to claim 1, wherein the illuminable component is constructed in one piece, in that the intermediate part has a carrier function for the arrangement of the luminous foil and, if required, of the additional foil on its underside, and a carrier function for fastening the insertion parts on its top side.

11. An illuminable component comprising:
a basic support having an opening;
a voltage transducer disposed in the opening of the basic support;
a luminous foil connected to the voltage transducer;
a transparent intermediate part, wherein the luminous foil is disposed between the basic support and the transparent intermediate part, and wherein the transparent intermediate part has an elevation; and
a non-illuminable part having two opposite sides, wherein the transparent intermediate part is disposed between the luminous foil and the non-illuminable part, wherein the elevation of the transparent intermediate part extends through the non-illuminable part from one side of the non-illuminable part to the other side and projects over to the other side, wherein the portion of the elevation projecting over the non-illuminable part forms a symbol, and wherein the voltage transducer is fastened to one of the other elements of the illuminable component.

12. The component according to claim 11, further comprising an additional transparent foil disposed between the luminous foil and the transparent intermediate part, wherein the transparent foil generates a colored and/or a metallic impression of the symbol in daylight.

13. The component according to claim 12, wherein the transparent foil includes a translucent (transluminescent) chrome foil and/or a colored foil.

14. The component according to claim 13, wherein the elevation has an arched surface which causes a uniform irradiation of the light generated by the luminous foil.

15. The component according to claim 14, wherein the intermediate part is attached to the transparent foil and to the non-illuminable part.

16. The component according to claim 11, wherein the intermediate part is attached to the luminous foil and to the non-illuminable part.

17. The component according to claim 11, wherein the illuminable component is disposed in a recess of a wall of a vehicle.

18. The component according to claim 11, wherein the voltage transducer causes a digital effect of illumination.

19. A method of making an illuminable component comprising:
placing a voltage transducer in an opening of a basic support;
connecting a luminous foil to the voltage transducer;
placing the luminous foil between the basic support and a transparent intermediate part having an elevation;
placing the transparent intermediate part between the luminous foil and a non-illuminable part such that the elevation of the transparent intermediate part extends through the non-illuminable part from one side of the non-illuminable part to the other side and projects over to the other side, wherein the portion of the elevation projecting over the non-illuminable part forms a symbol; and
fastening the voltage transducer to one of the other elements of the illuminable component.
